(19) United States
(12) Patent Application Publication
(10) Pub. No.: US 2019/0264697 A1
(43) Pub. Date: Aug. 29, 2019

(54) CENTRIFUGAL FAN

(71) Applicant: Nidec Corporation, Kyoto (JP)

(72) Inventors: Tomoyuki TSUKAMOTO, Kyoto (JP); Kazuhiko FUKUSHIMA, Kyoto (JP)

(21) Appl. No.: 16/267,577

(22) Filed: Feb. 5, 2019

(30) Foreign Application Priority Data
Feb. 26, 2018 (JP) 2018-031907

(51) Int. Cl. F04D 17/16; F04D 25/06; F04D 29/28; F04D 29/62; F04D 29/42; F04D 29/66

(52) U.S. Cl. CPC F04D 17/16; F04D 25/0606; F04D 29/281; F04D 29/288; F04D 29/624; F05B 2280/6012; F04D 29/666; F05B 2240/301; F05B 2240/14; F05B 2230/232; F05B 2260/96; F04D 29/4226

(57) ABSTRACT

A centrifugal fan includes a motor, a support body, a rotating body, and a housing. The motor includes a rotor hub that rotates around a central axis extending up and down. The support body is fixed to and rotates together with the rotor hub. The rotating body is different from the support body in material. The rotating body is a continuous porous body. The housing accommodates the rotating body, the support body, and the motor. The housing includes a first air inlet open in an axial direction and at least one air outlet open in a radial direction. A radially inner surface of the rotating body opposes a radially outer surface of the rotor hub with a gap interposed therebetween. The rotating body is fixed to at least one of an axially upper surface and an axially lower surface of the support body.

### CROSS REFERENCE TO RELATED APPLICATIONS

This application claims the benefit of priority to Japanese Patent Application No. 2018-031907 filed on Feb. 26, 2018. The entire contents of this application are hereby incorporated herein by reference.

### BACKGROUND OF THE INVENTION

### 1. Field of the Invention

The present disclosure relates to a centrifugal fan.

### 2. Description of the Related Art

General centrifugal fans rotate a plurality of blades to convert an incoming airflow parallel to the axial direction into a radial airflow and discharge the radial airflow. The centrifugal fan is mounted, for example, as a cooling fan, to an electronic device such as a notebook personal computer. The centrifugal fan to be mounted to the electronic device such as the notebook personal computer is required to have noise reduction.

In general centrifugal fans, however, turbulent flow which causes noise is generated in the vicinity of a radially distal end of each blade since the plurality of blades rotate. Specifically, the rotation of the plurality of blades generates a pressure difference in the circumferential direction between a front surface of each blade in the traveling direction and a rear surface in the traveling direction. As a result, an airflow flowing from the front surface in the traveling direction through the radially distal end of the blade toward the rear surface in the traveling direction is generated, and this airflow causes the turbulent flow.

### SUMMARY OF THE INVENTION

A centrifugal fan according to an exemplary embodiment of the present disclosure includes a motor, a support body, a rotating body, and a housing. The motor includes a rotor hub that rotates around a central axis extending up and down. The support body is fixed to the rotor hub and rotates together with the rotor hub. The rotating body is different in material from the support body. The rotating body is a continuous porous body. The housing accommodates the rotating body, the support body, and the motor. The housing includes a first air inlet open in an axial direction and at least one air outlet open in a radial direction. A radially inner surface of the rotating body opposes a radially outer surface of the rotor hub with a gap interposed therebetween. The rotating body is fixed to at least one of an axially upper surface and an axially lower surface of the support body.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1A is a plan view of a centrifugal fan according to a first exemplary embodiment of the present disclosure.

FIG. 1B is a plan view illustrating the inside of the centrifugal fan according to the first exemplary embodiment of the present disclosure.

FIG. 2 is a side view illustrating a portion of the centrifugal fan according to the first exemplary embodiment of the present disclosure.

FIG. 3 is a perspective view illustrating the inside of the centrifugal fan according to the first exemplary embodiment of the present disclosure.

FIG. 4 is a cross-sectional view illustrating a portion of the centrifugal fan according to the first exemplary embodiment of the present disclosure.

FIG. 5 is a plan view illustrating fixing points between a support body and a rotating body according to the first exemplary embodiment of the present disclosure.

FIG. 6 is a plan view illustrating a concave portion according to a second exemplary embodiment of the present disclosure.

FIG. 7 is a plan view illustrating a modified example of the concave portion according to the second exemplary embodiment of the present disclosure.

FIG. 8 is a plan view illustrating a modified example of the concave portion according to the second exemplary embodiment of the present disclosure.

FIG. 9 is a plan view illustrating a modified example of the concave portion according to the second exemplary embodiment of the present disclosure.

FIG. 10 is a plan view illustrating a modified example of the concave portion according to the second exemplary embodiment of the present disclosure.

FIG. 11A is a plan view illustrating a rotor hub and a support body according to a third exemplary embodiment of the present disclosure.

FIG. 11B is a cross-sectional view illustrating a rotating body according to the third exemplary embodiment of the present disclosure.

FIG. 12 is a plan view illustrating a rotor hub and a support body according to a fourth exemplary embodiment of the present disclosure.

FIG. 13 is a cross-sectional view of a centrifugal fan according to the fourth exemplary embodiment of the present disclosure.

FIG. 14 is a plan view of a centrifugal fan according to a fifth exemplary embodiment of the present disclosure.

FIG. 15 is a cross-sectional view illustrating a portion of the centrifugal fan according to the fifth exemplary embodiment of the present disclosure.

FIG. 16 is a bottom view of the centrifugal fan according to the fifth exemplary embodiment of the present disclosure.

FIG. 17 is a side view of a centrifugal fan according to another exemplary embodiment of the present disclosure.

### DETAILED DESCRIPTION OF THE PREFERRED EMBODIMENTS

Hereinafter, exemplary embodiments of the present disclosure will be described with reference to the drawings. However, the present disclosure is not limited to the following embodiments. In the drawings, the same or corresponding parts will be denoted by the same reference signs, and descriptions thereof will not be repeated. Further, points for which descriptions overlap each other will be sometimes omitted as appropriate.

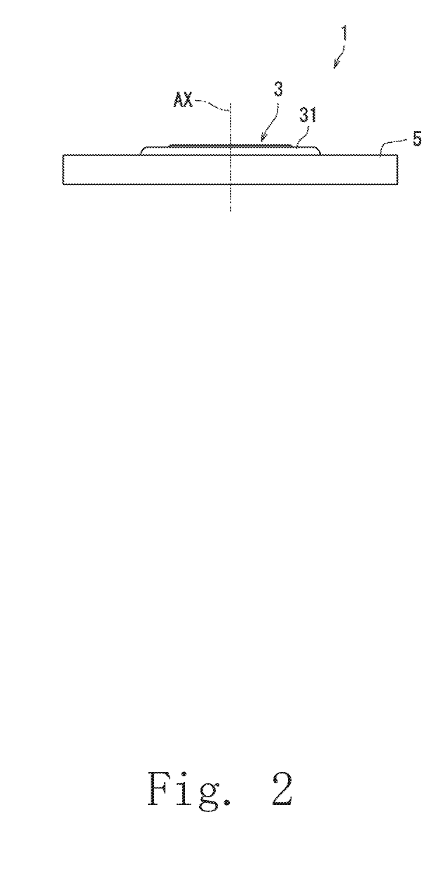

In the present specification, a direction in which a central axis AX (see FIG. 2) of a motor 3 extends will be described as an up-down direction for the sake of convenience. However, the up-down direction is defined for convenience of the description, and there is no intention that the direction of the central axis AX coincides with the vertical direction. In the present specification, a direction parallel to the central axis AX of the motor 3 will be referred to as an “axial direction”, a radial direction and a circumferential direction around the central axis AX of the motor 3 will be referred to as a “radial direction” and a “circumferential direction”. However, in practicality, there is no intention to limit the orientation during use of the centrifugal fan according to the present disclosure to such definitions. Incidentally, the “parallel direction” includes a substantially parallel direction.

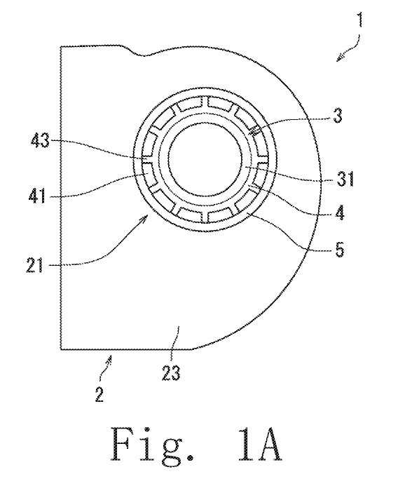

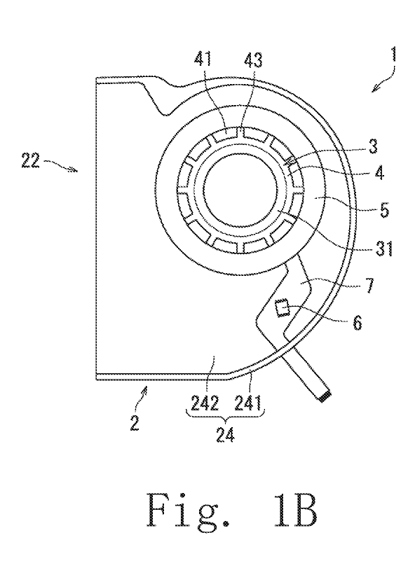

FIG. 1A is a plan view illustrating a centrifugal fan 1 according to a first embodiment. As illustrated in FIG. 1A, the centrifugal fan 1 includes a housing 2, a motor 3, a support body 4, and an annular rotating body 5. The housing 2 has an air inlet 21 that is open in the axial direction. Specifically, the housing 2 has a cover member 23, and the cover member 23 has the air inlet 21. In the present embodiment, the cover member 23 forms an upper wall portion of the housing 2.

FIG. 1B is a plan view illustrating the inside of the centrifugal fan 1 according to the first embodiment. Specifically, FIG. 1B illustrates the centrifugal fan 1 from which the cover member 23 illustrated in FIG. 1A has been removed. As illustrated in FIGS. 1A and 1B, the housing 2 accommodates the motor 3, the support body 4, and the rotating body 5.

Further, the housing 2 has an air outlet 22 that is open in a radial direction as illustrated in FIG. 1B. Specifically, the housing 2 has a case member 24. The case member 24 is covered with the cover member 23 illustrated in FIG. 1A. The case member 24 has a side wall portion 241, and the side wall portion 241 has an air outlet 22. Further, the case member 24 has a lower wall portion 242. The lower wall portion 242 opposes the cover member 23 illustrated in FIG. 1A in the axial direction.

As illustrated in FIG. 1B, the centrifugal fan 1 further includes a motor driver 6 and a wiring board 7. The motor driver 6 generates a drive signal to d rive the motor 3 based on a control signal transmitted from an external controller. The motor driver 6 is mounted to the wiring board 7. The wiring board 7 receives the control signal transmitted from the external controller and transmits the received control signal to the motor driver 6. Further, the wiring board 7 transmits the drive signal generated by the motor driver 6 to the motor 3. The housing 2 further accommodates the motor driver 6. In the present embodiment, the housing 2 accommodates a part of the wiring board 7.

FIG. 2 is a side view illustrating a part of the centrifugal fan 1 according to the first embodiment. Specifically, FIG. 2 illustrates the motor 3 and the rotating body 5. As illustrated in FIGS. 1A, 1B and 2, the motor 3 has a rotor hub 31. As illustrated in FIG. 2, the rotor hub 31 rotates about the central axis AX.

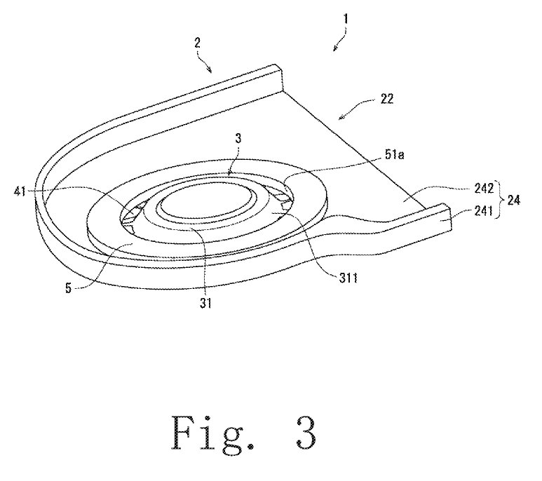

FIG. 3 is a perspective view illustrating the inside of the centrifugal fan 1 according to the first embodiment. Specifically, FIG. 3 illustrates the centrifugal fan 1 from which the cover member 23 illustrated in FIG. 1A has been removed. As illustrated in FIG. 3, the rotor hub 31 has a radially outer surface 311, and the rotating body 5 has a first radially inner surface 51a. The first radially inner surface 51a opposes the radially outer surface 311 of the rotor hub 31 with a gap interposed therebetween.

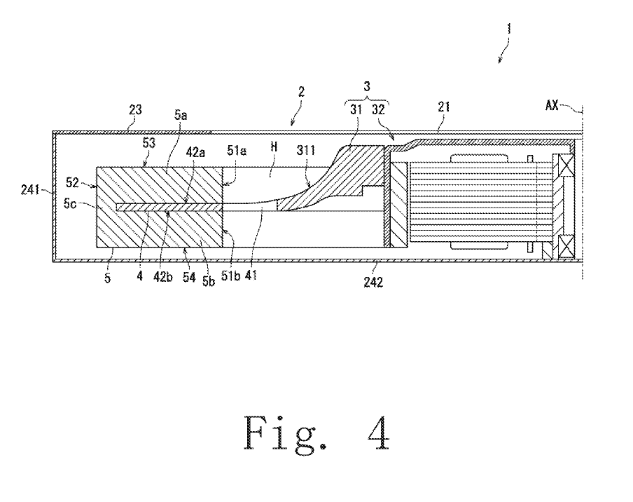

FIG. 4 is a cross-sectional view illustrating a part of the centrifugal fan 1 according to the first embodiment. Specifically, FIG. 4 illustrates cross sections of the housing 2, the motor 3, the support body 4, and the rotating body 5.

As illustrated in FIG. 4, the motor 3 has a motor unit 32. The motor unit 32 rotates the rotor hub 31 in the circumferential direction about the central axis AX. The support body 4 is fixed to the rotor hub 31 and rotates together with the rotor hub 31. Specifically, the support body 4 protrudes in the radial direction from the rotor hub 31. The rotor hub 31 protrudes axially upward from a proximal end portion of the support body 4. The rotor hub 31 and the support body 4 may be integrated or may be separate bodies.

The rotating body 5 is fixed to the support body 4 and extends in the circumferential direction. A material of the rotating body 5 is different from a material of the support body 4. The material of the rotating body 5 is, for example, a continuous porous body such as foamed urethane. The continuous porous body is a material which has a plurality of continuous air holes such that a wall between adjacent air holes is open and through which a fluid such as a gas can pass. For example, the material of the rotating body 5 may be an open-cell structure. The open-cell structure is a material which has a plurality of continuous air cells (air holes) such that a wall between adjacent air cells is open and through which a fluid such as a gas can pass. The material of the support body 4 is, for example, hard plastic.

In the present embodiment, the support body 4 has an axially upper surface 42a and an axially lower surface 42b. The axially upper surface 42a is a surface of the support body 4 on the axially upper side, and the axially lower surface 42b is a surface of the support body 4 on the axially lower side. Further, the rotating body 5 has an upper portion 5a, a lower portion 5b, and a connecting portion 5c. All the upper portion 5a, the lower portion 5b, and the connecting portion 5c are annular and extend in the circumferential direction.

The upper portion 5a of the rotating body 5 is arranged on the axially upper surface 42a of the support body 4, and the lower portion 5b of the rotating body 5 is arranged on the axially lower surface 42b of the support body 4. Therefore, the axially upper surface 42a of the support body 4 opposes the upper portion 5a of the rotating body 5 in the axial direction. Further, the axially lower surface 42b of the support body 4 opposes the lower portion 5b of the rotating body 5 in the axial direction.

The connecting portion 5c of the rotating body 5 connects the upper portion 5a and the lower portion 5b. Specifically, the connecting portion 5c extends in the axial direction on a radially outer side of the support body 4. The connecting portion 5c has an axially upper portion extending axially upward with respect to the support body 4 and an axially lower portion extending axially downward with respect to the support body 4. The axially upper portion of the connecting portion 5c is connected to the upper portion 5a and the axially lower portion of the connecting portion 5c is connected to the lower portion 5b.

The rotating body 5 has a second radially inner surface 51b in addition to the first radially inner surface 51a. Specifically, the upper portion 5a of the rotating body 5 has the first radially inner surface 51a, and the lower portion 5b of the rotating body 5 has the second radially inner surface 51b.

Further, the rotating body 5 has a radially outer surface 52, an axially upper surface 53, and an axially lower surface 54. The axially upper surface 53 of the rotating body 5 opposes the cover member 23 in the axial direction with a gap interposed therebetween. The radially outer surface 52 of the rotating body 5 opposes the side wall portion 241 in the radial direction with a gap interposed therebetween. The axially lower surface 54 of the rotating body 5 opposes the lower wall portion 242 in the axial direction with a gap interposed therebetween.

Next, the support body 4 will be further described with reference to FIGS. 1A, 1B, 3, and 4. As illustrated in FIGS. 1A, 1B, and 3, the support body 4 has a plurality of first through-holes 41. In the present embodiment, the plurality of first through-holes 41 is arranged in the circumferential direction. Further, the support body 4 has a rib portion 43 positioned between the adjacent first through-holes 41. As illustrated in FIG. 4, the first through-hole 41 penetrates the support body 4 in the axial direction. Further, the first through-hole 41 is arranged so as to be open in a gap H between the first radially inner surface 51a of the rotating body 5 and the radially outer surface 311 of the rotor hub 31. Incidentally, it is unnecessary to clearly define a boundary between the rotor hub 31 and the support body 4 as long as the rotor hub 31 has the radially outer surface 311 and the support body 4 has the axially upper surface 42a, the axially lower surface 42b, and the plurality of first through-holes 41.

Next, an operation of the centrifugal fan 1 will be described with reference to FIGS. 1A, 1B, and 2 to 4. When the rotor hub 31 rotates in the centrifugal fan 1, the support body 4 and the rotating body 5 rotate in the circumferential direction about the central axis AX.

When the rotating body 5 rotates in the circumferential direction, the air inside the rotating body 5 moves to the radially outer surface 52 of the rotating body 5 by a centrifugal force and is sent from the radially outer surface 52 of the rotating body 5 to the outside of the rotating body 5. The air sent from the radially outer surface 52 of the rotating body 5 to the outside of the rotating body 5 is sent to the outside from the air outlet 22.

On the other hand, when the air inside the rotating body 5 is sent to the outside of the rotating body 5, the air between the rotor hub 31 and the first radially inner surface 51a of the rotating body 5 is sucked from the first radially inner surface 51a into the inside of the rotating body 5. Similarly, the air outside the second radially inner surface 51b of the rotating body 5 is sucked into the inside of the rotating body 5 from the second radially inner surface 51b of the rotating body 5. As a result, the air outside the housing 2 is sucked into a space between the rotor hub 31 inside the housing 2 and the first radially inner surface 51a of the rotating body 5 from the air inlet 21. Further, a part of the air sucked between the rotor hub 31 and the first radially inner surface 51a of the rotating body 5 passes through the first through-hole 41 by the rib portion 43 of the support body 4.

Therefore, when the rotor hub 31 rotates, the air is sucked into the inside of the housing 2 from the air inlet 21, and the air sucked into the interior of the housing 2 is blown to the outside of the housing 2 from the air outlet 22.

When the rotating body 5 rotates in the circumferential direction, friction is generated between the axially upper surface 53 of the rotating body 5 and the air. As a result, the air existing in the gap between the axially upper surface 53 of the rotating body 5 and the cover member 23 moves to the radially outer surface 52 side of the rotating body 5. Similarly, friction is generated between the axially lower surface 54 of the rotating body 5 and the air. As a result, the air existing in the gap between the axially lower surface 54 and the lower wall portion 242 of the rotating body 5 moves to the radially outer surface 52 side of the rotating body 5. Therefore, airflow (reverse flow) flowing from the gap between the axially upper surface 53 of the rotating body 5 and the cover member 23 and the gap between the axially lower surface 54 of the rotating body 5 and the lower wall portion 242 to the air inlet 21 hardly occurs. Accordingly, the efficiency of the centrifugal fan 1 can be improved.

The centrifugal fan 1 according to the first embodiment has been described above with reference to FIGS. 1A, 1B, and 2 to 4. Although all of the first through-holes 41 are arranged to be open in the gap H in the present embodiment, a part of each of the first through-holes 41 may be arranged to be open in the gap H. Alternatively, the plurality of first through-holes 41 may include the first through-hole 41 that is entirely open in the gap H and the first through-hole 41 that is partially open in the gap H. Alternatively, the plurality of first through-holes 41 may include the first through-holes 41 entirely covered with the upper portion 5a and the lower portion 5b of the rotating body 5.

According to the present embodiment, noise can be reduced by using the annular rotating body made of the continuous porous body. In other words, it is possible to achieve noise reduction. Specifically, in a centrifugal fan using a rotating body having a plurality of blades, turbulent flow that causes noise is generated due to a pressure difference generated in the vicinity of a radially distal end of each blade. According to the present embodiment, however, since the annular rotating body made of the continuous porous body is rotated, the turbulent flow is less likely to occur as compared with the centrifugal fan that rotates the plurality of blades. Therefore, the noise can be reduced.

According to the present embodiment, it is possible to use a material suitable for the rotating body 5 and a material suitable for the support body 4. For example, the material of the rotating body 5 is required to be a material that facilitates production of a continuous porous body. The material of the support body 4 is required to be a material that is thin but is hardly deformed under an external force.

According to the present embodiment, the annular rotating body made of the continuous porous body is arranged on both sides of the support body 4. Specifically, the rotating body formed of the upper portion 5a of the rotating body 5 and the axially upper portion of the connecting portion 5c of the rotating body 5 is arranged on the axially upper surface 42a side of the support body 4. Further, the rotating body formed of the lower portion 5b of the rotating body 5 and the axially lower portion of the connecting portion 5c of the rotating body 5 is arranged on the axially lower surface 42b side of the support body 4. As a result, the amount of air blowing is increased, and a PQ characteristic is improved. The PQ characteristic indicates a relationship between air volume and static pressure at the air inlet 21 and the air outlet 22. In the following description, the rotating body formed of the upper portion 5a of the rotating body 5 and the axially upper portion of the connecting portion 5c of the rotating body 5 will be referred to as a “first rotating body”, and the rotating body formed of the lower portion 5b of the rotating body 5 and the axially lower portion of the connecting portion 5c will be referred to as a “second rotating body” in some cases.

According to the present embodiment, each of the first rotating body and the second rotating body is thinner than one rotating body having a total thickness of a thickness of the first rotating body in the axial direction and a thickness of the second rotating body in the axial direction. Therefore, even when a soft material such as an open-cell structure is used as the material of the rotating body 5, it is possible to make each thickness of the first rotating body and the second rotating body in the axial direction thin to suppress the deformation amount of the rotating body 5 according to the present embodiment. For example, the thickness of the rotating body made of the soft material in the axial direction decreases while extending in the radial direction by a centrifugal force. As the thickness of the rotating body in the axial direction becomes thinner, it is possible to suppress the amount of extension in the radial direction and the amount of decrease of the thickness in the axial direction. A thickness of the first rotating body in the axial direction indicates a distance (length) from the axially upper surface 42a of the support body 4 to the axially upper surface 53 of the rotating body 5, and a thickness of the second rotating body in the axial direction indicates a distance (length) from the axially lower surface 42b of the support body 4 to the axially lower surface 54 of the rotating body 5.

According to the present embodiment, it is possible to make the thickness of the first rotating body in the axial direction thin. Therefore, since the thickness of the rotating body opposing the radially outer surface 311 of the rotor hub 31 can be made thin, the length of the rotor hub 31 in the axial direction can be shortened. Accordingly, it is possible to suppress the deformation of the rotor hub 31 caused by the centrifugal force or the like during the rotation by shortening the length of the rotor hub 31 in the axial direction.

According to the present embodiment, the first radially inner surface 51a of the rotating body 5 opposes the radially outer surface 311 of the rotor hub 31 with the gap H interposed therebetween. Therefore, air easily enters the inside of the rotating body 5 from the first radially inner surface 51a of the rotating body 5, and it is possible to increase the amount of air blowing of the centrifugal fan 1.

According to the present embodiment, since the rotating body 5 is configured using the continuous porous body, it is possible to reduce a weight of the rotating body 5. Therefore, it is easy to take eccentric balance of the rotating body 5. For example, it is possible to achieve weight reduction of the rotating body 5 by using the open-cell structure as the material of the rotating body 5. Further, the rotating body 5 can be rotated at a high speed by achieving the weight reduction of the rotating body 5. Since the rotating body 5 is rotated at a high speed, it is possible to stably rotate the rotating body 5 even if a load fluctuates.

According to the present embodiment, the axially upper surface 53 of the rotating body 5 moves the air to the radially outer surface 52 side of the rotating body 5. Similarly, the axially lower surface 54 of the rotating body 5 moves the air to the radially outer surface 52 side of the rotating body 5. Therefore, the amount of air blowing of the centrifugal fan 1 can be increased.

Since the support body 4 has the first through-hole 41 according to the present embodiment, it is possible to reduce the weight of the support body 4. Therefore, the rotating body 5 can be rotated at a high speed. Further, the air having passed through the first through-hole 41 is moved to the radially outer surface side of the rotating body 5 by the second rotating body. Therefore, the air efficiently moves toward the air outlet 22 side.

According to the present embodiment, the open-cell structure can be used as the material of the rotating body 5. Since the open-cell structure is a material which is easily processed, the rotating body 5 is easily manufactured by using the open-cell structure as the material of the rotating body 5.

Since the open-cell structure is used as the material of the rotating body 5, the rotating body 5 can be made soft. When the rotating body 5 is soft, the housing 2 is not easily damaged even if the rotating body 5 comes into contact with the housing 2. Therefore, it is possible to narrow the gap between the rotating body 5 and the housing 2 by using the open-cell structure as the material of the rotating body 5. In other words, it is possible to achieve size reduction of the centrifugal fan 1.

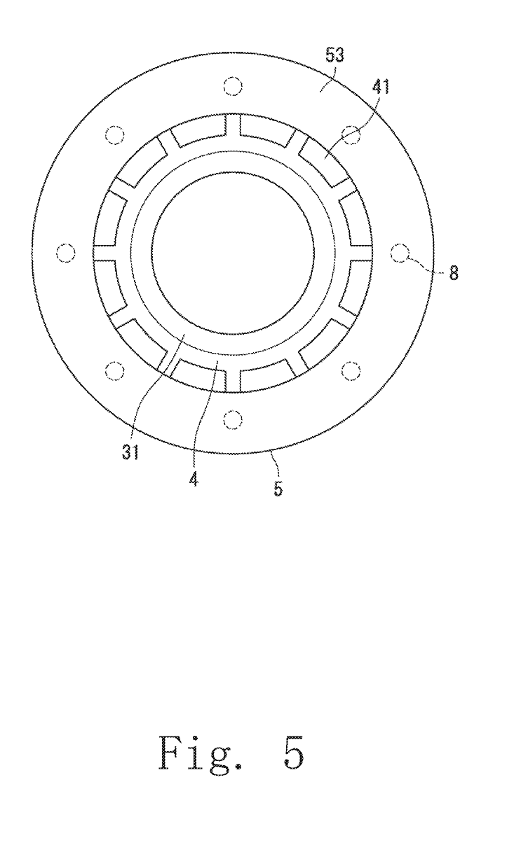

Next, a method of fixing the rotating body 5 will be described with reference to FIG. 5. FIG. 5 is a plan view illustrating fixing points 8 between the support body 4 and the rotating body 5 according to the first embodiment. Specifically, FIG. 5 illustrates the rotor hub 31, the support body 4, and the rotating body 5.

In the present embodiment, the rotating body 5 and the support body 4 are welded at the plurality of fixing points 8. Therefore, the rotating body 5 and the support body 4 are integrated at the plurality of fixing points 8.

Incidentally, only the upper portion 5a of the rotating body 5 and the support body 4 may be welded, only the lower portion 5b of the rotating body 5 and the support body 4 may be welded, or the upper portion 5a and the lower portion 5b of the rotating body 5 and the support body 4 may be welded. In other words, the rotating body 5 is fixed to at least one of the axially upper surface 42a and the axially lower surface 42b of the support body 4. Further, the upper portion 5a of the rotating body 5 and the support body 4 may be fixed at one point, the lower portion 5b of the rotating body 5 and the support body 4 may be fixed at one point, or the rotating body 5 and the support body 4 may be fixed at one point. Further, the fixing point between the upper portion 5a of the rotating body 5 and the support body 4 and the fixing point between the lower portion 5b of the rotating body 5 and the support body 4 may oppose each other in the axial direction or does not necessarily oppose each other in the axial direction.

Since the rotating body 5 and the support body 4 are welded according to the present embodiment, the joining strength between the rotating body 5 and the support body 4 hardly deteriorates so that it is possible to fix the rotating body 5 and the support body 4 for a long period of time with a stable strength. Further, it is possible to fix the rotating body 5 and the support body 4 more firmly by welding the rotating body 5 and the support body 4 at a plurality of points.

Incidentally the case where the rotating body 5 and the support body 4 are welded has been described in the present embodiment, the rotating body 5 and the support body 4 may be fixed by an adhesive or a pressure-sensitive adhesive. More specifically, only the upper portion 5a of the rotating body 5 and the support body 4 may be fixed by the adhesive or the pressure-sensitive adhesive, only the lower portion 5b of the rotating body 5 and the support body 4 are fixed by the adhesive or the pressure-sensitive adhesive, or the upper portion 5a and the lower portion 5b of the rotating body 5 and the support body 4 may be fixed by the adhesive or the pressure-sensitive adhesive.

When fixing the rotating body 5 and the support body 4 by the adhesive or the pressure-sensitive adhesive, the work of fixing the rotating body 5 and the support body 4 becomes easy. Specifically, it is possible to fix the rotating body 5 and the support body 4 without using special equipment.

When the rotating body 5 and the support body 4 are welded and fixed, pores of the rotating body 5 are damaged at the fixing point. Further, when the rotating body 5 and the support body 4 are fixed by using the adhesive, there is a possibility that the adhesive locally fills the pores of the rotating body 5. On the other hand, the pores of the rotating body 5 can be maintained by using the pressure-sensitive adhesive.

In the case of using the adhesive or the pressure-sensitive adhesive, a primer may be attached to at least one of the rotating body 5 and the support body 4 at the fixing point. The adhesiveness of the rotating body 5 can be improved by attaching the primer to the support body 4. Similarly, the adhesiveness of the support body 4 can be improved by attaching the primer to the support body 4. Therefore, the rotating body 5 and the support body 4 can be more firmly fixed by attaching the primer to at least one of the rotating body 5 and the support body 4.

The adhesive or the pressure-sensitive adhesive that adheres to the rotating body 5 and the adhesive or the pressure-sensitive that adheres to the support body 4 may be different from each other. Specifically, an adhesive or a pressure-sensitive adhesive suitable for the rotating body 5 and an adhesive or a pressure-sensitive adhesive suitable for the support body 4 may be used. The rotating body 5 and the support body 4 can be more firmly fixed by using the adhesive or the pressure-sensitive adhesive suitable for the rotating body 5 and the adhesive or the pressure-sensitive adhesive suitable for the support body 4.

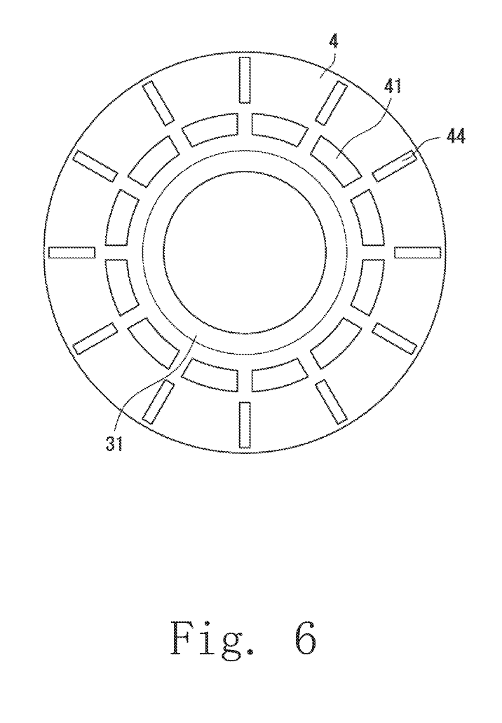

Next, a second embodiment of the present disclosure will be described with reference to FIGS. 6 to 10. However, items different from those of the first embodiment will be described, and descriptions for the same items as those of the first embodiment will be omitted. In the second embodiment, the support body 4 has at least one concave portion 44, which is different from the first embodiment. Specifically, both the axially upper surface 42a and the axially lower surface 42b of the support body 4 have the concave portions 44. Hereinafter, the concave portion 44 of the axially upper surface 42a of the support body 4 will be described.

FIG. 6 is a plan view illustrating the concave portion according to the second embodiment. Specifically, FIG. 6 illustrates the axially upper surface 42a of the support body 4. As illustrated in FIG. 6, the axially upper surface 42a of the support body 4 has the plurality of concave portions 44. The plurality of concave portions 44 opposes the upper portion 5a of the rotating body 5, which has been described with reference to FIG. 4, in the axial direction. In the present embodiment, the concave portion 44 is a groove extending in the radial direction, and the plurality of concave portions 44 is arranged in a radial shape. Since a description overlaps with the description regarding the concave portion 44 of the axially upper surface 42a, the description regarding the concave portion 44 of the axially lower surface 42b of the support body 4 will be omitted.

The second embodiment has been described above with reference to FIG. 6. According to the present embodiment, the concave portion 44 can be used as an adhesive reservoir. Therefore, it is possible to reliably fix the rotating body 5 and the support body 4 using the adhesive. Further, when the support body 4 is eccentric, the concave portion 44 can be used as a filling point of a balance material that causes the center of gravity of the support body 4 to coincide with the center of the support body 4. Further, the amount of an adhesive or a pressure-sensitive adhesive can be easily adjusted by attaching the adhesive or the pressure-sensitive adhesive to the concave portion 44. Therefore, it is possible to use the adhesive or the pressure-sensitive adhesive as the balance material. Further, it is possible to use the concave portion 44 as a mark for positioning the rotating body 5 in the case of welding the rotating body 5 and the support body 4.

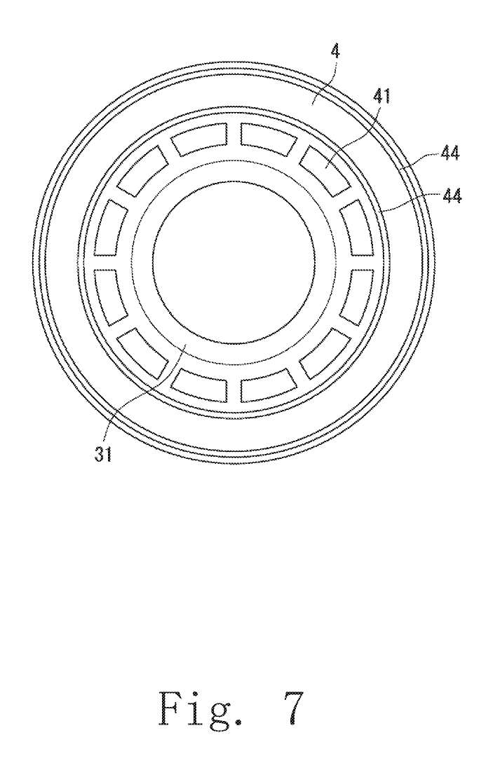

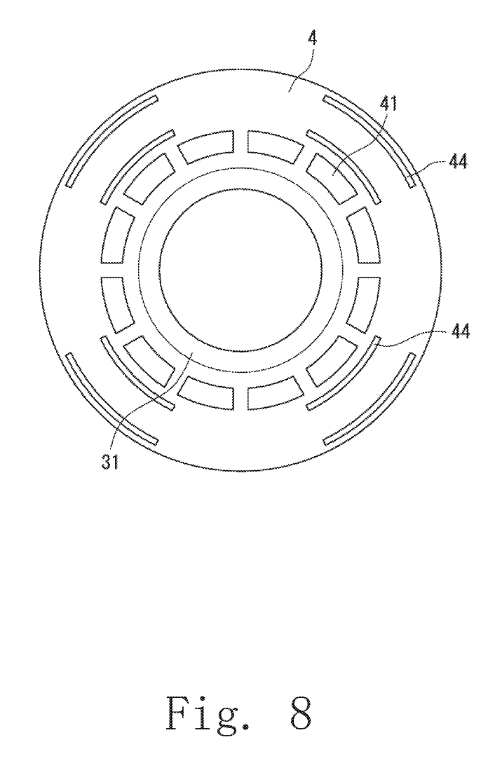

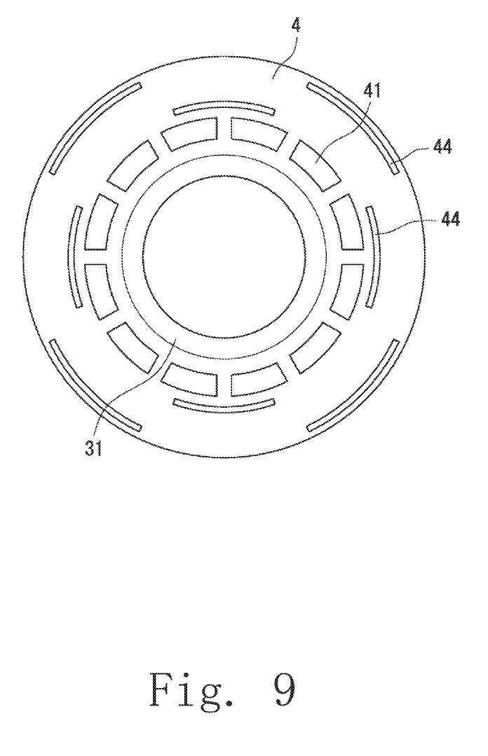

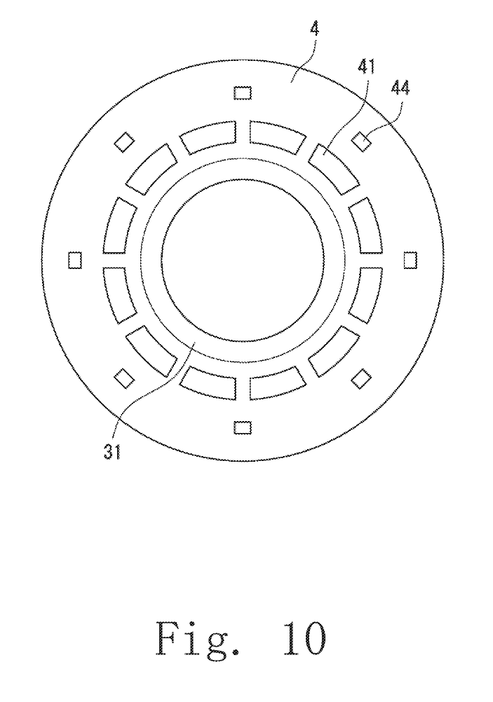

Although the concave portion 44 extending in the radial direction has been described in the present embodiment, a shape of the concave portion 44 is not particularly limited. For example, the concave portion 44 may be an annular groove extending in the circumferential direction as illustrated in FIG. 7. Alternatively, the concave portion 44 may be an arcuate groove extending in the circumferential direction as illustrated in FIGS. 8 and 9. Alternatively, the concave portion 44 may be a hole having a bottom surface as illustrated in FIG. 10. FIGS. 7 to 10 are views illustrating modified examples of the concave portion 44.

Although the case where the axially upper surface 42a of the support body 4 has the plurality of concave portions 44 has been described, the axially upper surface 42a of the support body 4 may have the single concave portion 44. Similarly, the axially lower surface 42b of the support body 4 may have the single concave portion 44 or may have the plurality of concave portions 44. Further, the number of the concave portions 44 of the axially upper surface 42a of the support body 4 and the number of the concave portions 44 of the axially lower surface 42b of the support body 4 may coincide with each other or do not necessarily coincide with each other. Further, a position of the concave portion 44 of the axially upper surface 42a of the support body 4 and a position of the concave portion 44 of the axially lower surface 42b of the support body 4 may coincide with each other or does not necessarily coincide with each other. Further, a shape of the concave portion 44 of the axially upper surface 42a of the support body 4 and a shape of the concave portion 44 of the axially lower surface 42b of the support body 4 may coincide with each other or does not necessarily coincide with each other. For example, the concave portion 44 of the axially upper surface 42a of the support body 4 may be a groove extending in the radial direction, and the concave portion 44 of the axially lower surface 42b of the support body 4 may be a groove extending in the circumferential direction.

In the present embodiment, both the axially upper surface 42a and the axially lower surface 42b of the support body 4 have the concave portions 44, but only one of the axially upper surface 42a and the axially lower surface 42b of the support body 4 may have the concave portion 44.

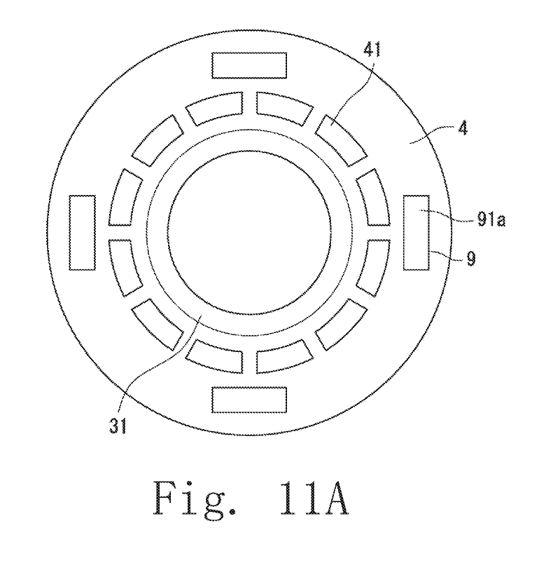

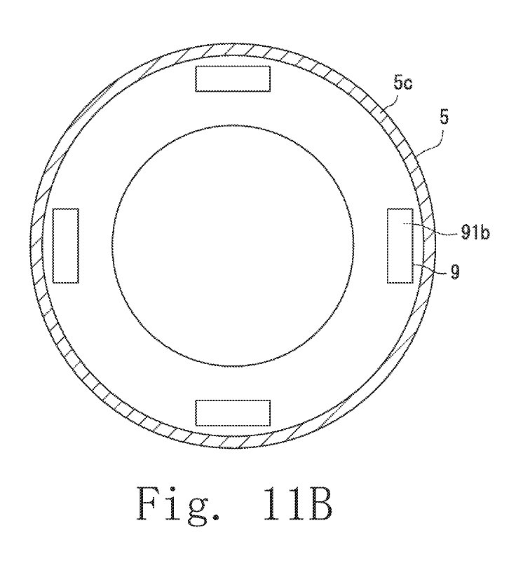

Next, a third embodiment of the present disclosure will be described with reference to FIGS. 11A and 11B. However, items different from those of the first and second embodiments will be described, and descriptions for the same items as those of the first and second embodiments will be omitted. The centrifugal fan 1 according to the third embodiment includes at least one base member 9 arranged between the rotating body 5 and the support body 4 and the rotating body 5 and the support body 4 are fixed by the base member 9, which is different from the first and second embodiments. The base member 9 is, for example, a double-sided tape.

FIG. 11A is a plan view illustrating the rotor hub 31 and the support body 4 according to the third embodiment. FIG. 11B is a cross-sectional view illustrating the rotating body 5 according to the third embodiment. Specifically, FIG. 11A illustrates the axially upper surface 42a of the support body 4 to which a plurality of the base members 9 has been attached. FIG. 11B illustrates the rotating body 5 to which the plurality of base members 9 has been attached. More specifically, FIG. 11B illustrates the axially lower surface of the upper portion 5a of the rotating body 5. When fixing the rotating body 5 and the support body 4, the rotating body 5 and the support body 4 may be fixed after pasting the base member 9 to the support body 4 as illustrated in FIG. 11A, or the rotating body 5 and the support body 4 may be fixed after pasting the base member 9 to the rotating body 5 as illustrated in FIG. 11B.

As illustrated in FIG. 11A, the centrifugal fan 1 according to the present embodiment includes the plurality of base members 9. The base member 9 illustrated in FIG. 11A fixes the axially upper surface 42a of the support body 4 and the upper portion 5a of the rotating body 5. Specifically, each of the base members 9 has a first contact surface 91a. Each of the base member 9 is arranged between the support body 4 and the upper portion 5a of the rotating body 5. The first contact surface 91a comes into contact with the upper portion 5a of the rotating body 5. The first contact surface 91a has a pressure-sensitive adhesive or an adhesive. Further, each of the base members 9 further has a second contact surface 91b as illustrated in FIG. 11B. The second contact surface 91b comes into contact with the axially upper surface 42a of the support body 4. The second contact surface 91b has a pressure-sensitive adhesive or an adhesive. Since a description overlaps with the description regarding the base member 9 that fixes the upper portion 5a of the rotating body 5 and the support body 4, the description regarding the base member 9 that fixes the lower portion 5b of the rotating body 5 and the support body 4 will be omitted.

The third embodiment has been described above with reference to FIGS. 11A and 11B. Since the base member 9 is used according to the present embodiment, the work of fixing the rotating body 5 and the support body 4 becomes easy. Further, it is possible to stabilize the quality of a product.

Although the case where the plurality of base members 9 is arranged on the axially upper surface 42a of the support body 4 has been described in the present embodiment, the single base member 9 may be arranged on the axially upper surface 42a of the support body 4. Similarly, the single base member 9 may be arranged on the axially lower surface 42b of the support body 4, or the plurality of base members 9 may be arranged. Further, the number of the base members 9 arranged on the axially upper surface 42a of the support body 4 and the number of the base members 9 arranged on the axially lower surface 42b of the support body 4 may coincide with each other or do not necessarily coincide with each other. Further, a position of the base member 9 arranged on the axially upper surface 42a of the support body 4 and a position of the base member 9 arranged on the axially lower surface 42b of the support body 4 may coincide with each other or do not necessarily coincide with each other.

Although the base member 9 is arranged on both the axially upper surface 42a and the axially lower surface 42b of the support body 4 in the present embodiment, the base member 9 may be arranged only on one of the axially upper surface 42a and the axially lower surface 42b of the support body 4.

The pressure-sensitive adhesive or the adhesive of the first contact surface 91a may be different from the pressure-sensitive adhesive or the adhesive of the second contact surface 91b. Specifically, a pressure-sensitive adhesive or an adhesive suitable for the rotating body 5 and a pressure-sensitive adhesive or an adhesive suitable for the support body 4 may be used. The rotating body 5 and the support body 4 can be more firmly fixed by using the pressure-sensitive adhesive or the adhesive suitable for the rotating body 5 and the pressure-sensitive adhesive or the adhesive suitable for the support body 4.

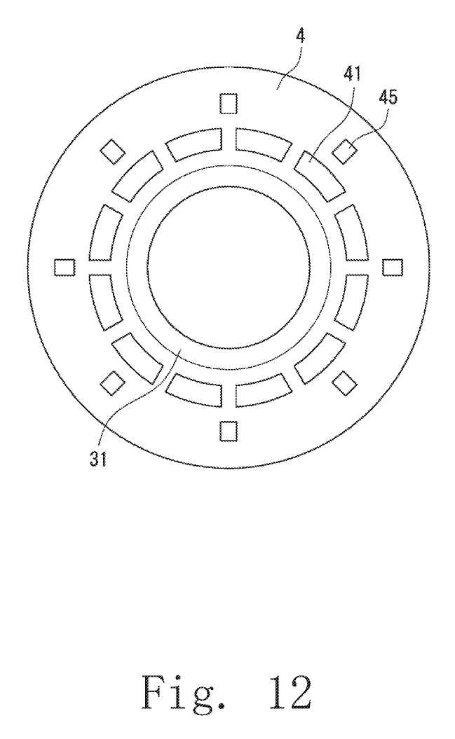

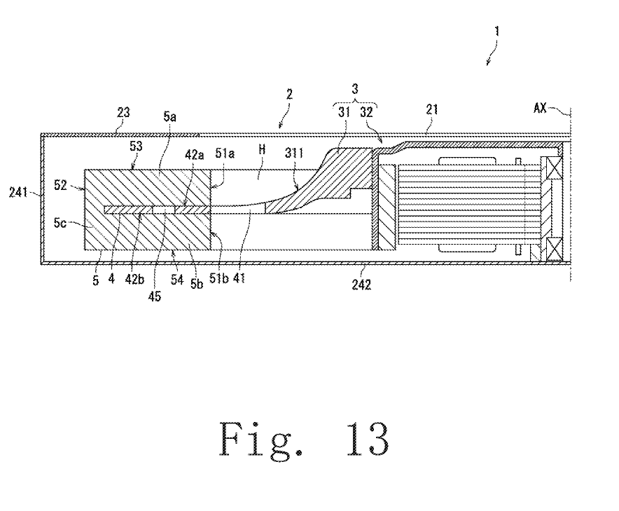

Next, a fourth embodiment will be described with reference to FIGS. 12 and 13. However, items different from those of the first to third embodiments will be described, and descriptions for the same items as those of the first to third embodiments will be omitted. The support body 4 of the centrifugal fan 1 according to the fourth embodiment has a second through-hole 45, which is different from the first to third embodiments.

FIG. 12 is a plan view illustrating the rotor hub 31 and the support body 4 according to the fourth embodiment. FIG. 13 is a cross-sectional view illustrating a part of the centrifugal fan according to the fourth embodiment. Specifically, FIG. 13 illustrates cross sections of the housing 2, the motor 3, the support body 4, and the rotating body 5.

As illustrated in FIG. 12, the support body 4 has a plurality of the second through-holes 45. As illustrated in FIG. 13, the second through-hole 45 is arranged in a region where the upper portion 5a of the rotating body 5 and the lower portion 5b of the rotating body 5 oppose each other in the axial direction, and penetrates the support body 4 in the axial direction. In the present embodiment, the upper portion 5a of the rotating body 5 and the lower portion 5b of the rotating body 5 are connected via the second through-hole 45.

Specifically, the upper portion 5a of the rotating body 5 and the lower portion 5b of the rotating body 5 are welded via the second through-hole 45. Alternatively, the upper portion 5a of the rotating body 5 and the lower portion 5b of the rotating body 5 are connected via the second through-hole 45 by an adhesive or a pressure-sensitive adhesive. In other words, the upper portion 5a of the rotating body 5 and the lower portion 5b of the rotating body 5 are connected via the adhesive or the pressure-sensitive adhesive. For example, the upper portion 5a of the rotating body 5 and the lower portion 5b of the rotating body 5 can be connected via the adhesive or the pressure-sensitive adhesive by filling the second through-hole 45 with the adhesive or the pressure-sensitive adhesive. Incidentally, it is preferable to use an adhesive or a pressure-sensitive adhesive in an amount equal to or larger than the volume of the second through-hole 45 when filling the second through-hole 45 with the adhesive or the pressure-sensitive adhesive. The upper portion 5a of the rotating body 5 and the lower portion 5b of the rotating body 5 can be more reliably connected by using the adhesive or the pressure-sensitive adhesive agent in the amount equal to or larger than the volume of the second through-hole 45.

The fourth embodiment has been described above with reference to FIGS. 12 and 13. According to the present embodiment, the upper portion 5a of the rotating body 5 and the lower portion 5b of the rotating body 5 are connected via the second through-hole 45. Therefore, the rotating body 5 can be fixed to the support body 4. Further, a method of fixing the rotating body 5 and a material for fixing the rotating body 5 can be selected depending on the material of the rotating body 5 regardless of the material of the support body 4 in order to connect the upper portion 5a of the rotating body 5 and the lower portion 5b of the rotating body 5. Although the case where the support body 4 has the plurality of second through-holes 45 has been described, the support body 4 may have the single second through-hole 45.

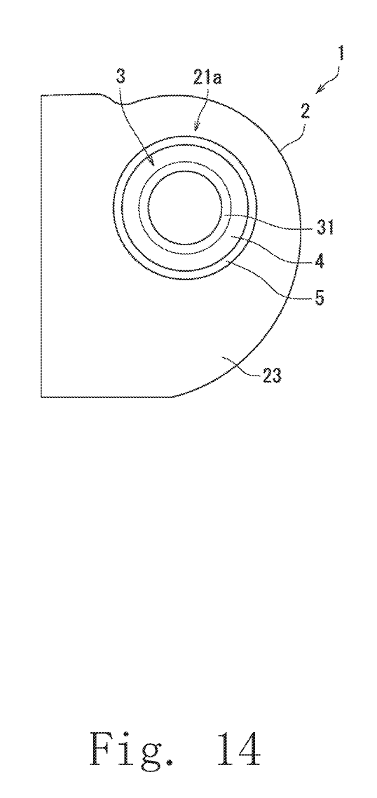

Next, a fifth embodiment will be described with reference to FIGS. 14 to 16. However, items different from those of the first to fourth embodiments will be described, and descriptions for the same items as those of the first to fourth embodiments will be omitted. The centrifugal fan 1 according to the fifth embodiment is different from the first to fourth embodiments in terms of the lower wall portion 242.

FIG. 14 is a plan view illustrating the centrifugal fan 1 according to the fifth embodiment. As illustrated in FIG. 14, the cover member 23 of the housing 2 according to the fifth embodiment has a first air inlet 21a that is open in the axial direction.

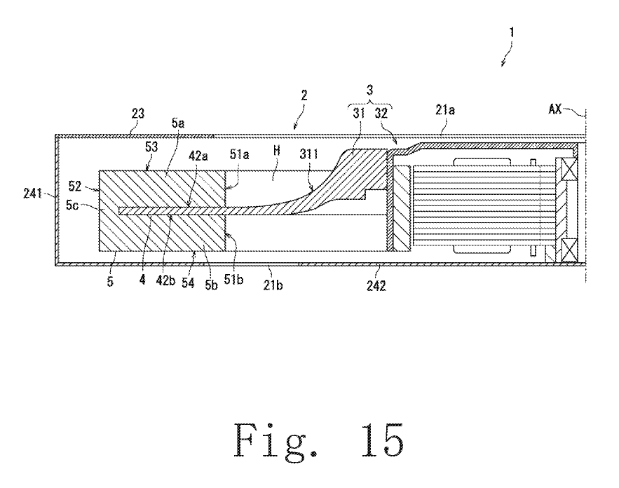

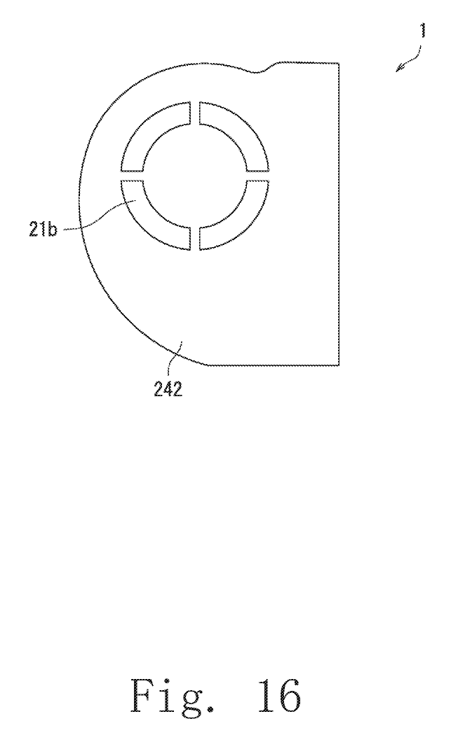

FIG. 15 is a cross-sectional view illustrating a part of the centrifugal fan 1 according to the fifth embodiment. Specifically, FIG. 15 illustrates cross sections of the housing 2, the motor 3, the support body 4, and the rotating body 5. FIG. 16 is a bottom view illustrating the centrifugal fan 1 according to the fifth embodiment.

As illustrated in FIGS. 15 and 16, the lower wall portion 242 of the housing 2 has a plurality of second air inlets 21b that is open in the axial direction.

The centrifugal fan 1 according to the fifth embodiment has been described above with reference to FIGS. 14 to 16. According to the fifth embodiment, air is sucked into the inside of the housing 2 from the first air inlet 21a and the second air inlet 21b as the rotating body 5 rotates. Therefore, it is possible to increase the amount of air blowing.

Although the lower wall portion 242 has the plurality of second air inlets 21b in the present embodiment, the lower wall portion 242 may have the single second air inlet 21b. Further, the support body 4 does not have the first through-hole 41, which has been described with reference to the first embodiment, in the present embodiment as illustrated in FIGS. 14 and 15, but the support body 4 may have the first through-hole 41. Since the support body 4 has the first through-hole 41, it is possible to reduce the weight of the support body 4.

The first to fifth embodiments of the present disclosure have been described above with reference to the drawings. However, the present disclosure is not limited to the above-described embodiments, and can be implemented in various modes without departing from a gist thereof.

For example, the housing 2 has the single air outlet 22 in the embodiments according to the present disclosure, but the housing 2 may have a plurality of the air outlets 22.

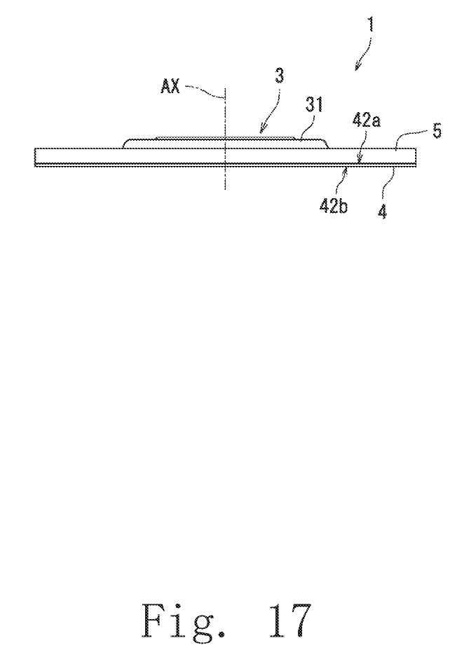

Although the upper portion 5a of the rotating body 5 is arranged on the axially upper surface 42a of the support body 4, and the lower portion 5b of the rotating body 5 is arranged on the axially lower surface 42b of the support body 4 in the embodiments of the present disclosure, the rotating body 5 may be arranged only on the axially upper surface 42a of the support body 4 as illustrated in FIG. 17.

FIG. 17 is a side view illustrating a part of the centrifugal fan 1 according to another embodiment. More specifically, FIG. 17 illustrates the motor 3 and the rotating body 5. In the centrifugal fan 1 illustrated in FIG. 17, the rotating body 5 is fixed to the axially upper surface 42a of the support body 4.

Alternatively, the rotating body 5 may be arranged only on the axially lower surface 42b of the support body 4. When the rotating body 5 is arranged only on the axially lower surface 42b of the support body 4, the rotor hub 31 may protrude axially downward.

The present disclosure is suitably applicable to, for example, a centrifugal fan.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A centrifugal fan comprising:
a motor including a rotor hub rotatable about a central axis extending up and down;
a support body fixed to the rotor hub and rotatable together with the rotor hub;
a rotating body made of a material different from a material of the support body and defined by a continuous porous body; and
a housing to house the rotating body, the support body, and
the motor; wherein
the housing includes a first air inlet open in an axial direction and at least one air outlet open in a radial direction;
a radially inner surface of the rotating body opposes a radially outer surface of the rotor hub with a gap interposed therebetween; and
the rotating body is fixed to at least one of an axially upper surface and an axially lower surface of the support body.

2. The centrifugal fan according to claim 1, wherein
the support body includes a plurality of first through-holes penetrating in the axial direction and a rib portion positioned between the first through-holes adjacent to each other; and
at least one of the plurality of first through-holes includes at least a portion open in the gap between the radially inner surface of the rotating body and the radially outer surface of the rotor hub.

3. The centrifugal fan according to claim 1, wherein the rotating body is located on the axially upper surface or the axially lower surface of the support body.

4. The centrifugal fan according to claim 1, wherein the rotating body extends from the axially upper surface to the axially lower surface of the support body.

5. The centrifugal fan according to claim 4, wherein the rotating body includes an upper portion located on the axially upper surface of the support body and a lower portion located on the axially lower surface of the support body.

6. The centrifugal fan according to claim 1, wherein the rotating body and the support body are welded.

7. The centrifugal fan according to claim 6, wherein the rotating body and the support body are welded at a plurality of points.

8. The centrifugal fan according to claim 1, wherein the rotating body and the support body are fixed by an adhesive or a pressure-sensitive adhesive.

9. The centrifugal fan according to claim 8, wherein the rotating body and the support body are fixed by a primer attached to at least one of the rotating body and the support body, and the adhesive or the pressure-sensitive adhesive.

10. The centrifugal fan according to claim 8, wherein the adhesive or the pressure-sensitive adhesive attached to the rotating body is different from the adhesive or the pressure-sensitive adhesive attached to the support body.

11. The centrifugal fan according to claim 1, wherein
a surface of the support body opposing the rotating body in the axial direction includes at least one concave portion; and
the concave portion opposes the rotating body in the axial direction.

12. The centrifugal fan according to claim 11, wherein the concave portion includes a groove extending in the radial direction.

13. The centrifugal fan according to claim 11, wherein the concave portion includes a groove extending in a circumferential direction.

14. The centrifugal fan according to claim 11, wherein the concave portion includes a hole including a bottom surface.

15. The centrifugal fan according to claim 1, further comprising a base between the rotating body and the support body; wherein
the base includes a first contact surface in contact with the rotating body, and a second contact surface in contact with the support body;
the first contact surface includes a pressure-sensitive adhesive or an adhesive; and
the second contact surface includes a pressure-sensitive adhesive or an adhesive.

16. The centrifugal fan according to claim 15, wherein the pressure-sensitive adhesive or the adhesive on the first contact surface is different from the pressure-sensitive adhesive or the adhesive on the second contact surface.

17. The centrifugal fan according to claim 5, wherein
the support body includes a second through-hole located in a region where the upper portion opposes the lower portion in the axial direction; and
the upper portion and the lower portion are connected via the second through-hole.

18. The centrifugal fan according to claim 1, wherein
the housing includes an upper wall portion and a lower wall portion opposing each other in the axial direction;
the upper wall portion includes the first air inlet and
the lower wall portion includes a second air inlet open in the axial direction.

19. The centrifugal fan according to claim 1, wherein a material of the rotating body includes an open-cell structure.
